(19) United States
(12) Patent Application Publication
(10) Pub. No.: US 2008/0282353 A1
(43) Pub. Date: Nov. 13, 2008

(54) Securely Linked Media Carrying Different Versions of the Same Computer Code

(75) Inventors: Franciscus Lucas Antonius Johannes Kamperman, Eindhoven (NL); Declan Patrick Kelly, Shanghai (CN); Steven Broeils Luitjens, Eindhoven (NL); Wilhemus Franciscus Johannes Fontijn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/571,015

(22) PCT Filed: Jun. 21, 2005
(86) PCT No.: PCT/IB2005/052033

§ 371 Date: Dec. 20, 2006

(30) Foreign Application Priority Data
Jun. 29, 2004 (EP) 04103033.9

(51) Int. Cl. G06F 1/00

(52) U.S. Cl. 726/26

(57) ABSTRACT

A means of delivering software comprises at least two storage media comprising at least two different versions of a software program. A first version of the software program comprises a full version of the program and a second version comprises a limited version of the program. Due to the presence of identification means, such as a security tag, the first version of the software program can only be executed in the presence of to second storage medium, or vice versa. The security tag may be an RF-ID dongle. Also, a system and a method is provided, for executing data stored on a data carrier, and wherein related data are stored on two separate data carriers. At least one of the data carriers comprises identification means, and the presence of this identification means authorizes the use of one of the data carriers in one of the devices.

The present invention relates to a method of securely linking media carrying different versions of the same computer code and to means of delivering software, wherein the means comprises at least two storage media, comprising at least two different versions of a software program, e.g. in the form of computer code.

It is known in the art to make authentication keys for software programs. A particular software program may thus be provided with an authentication key, such as a dongle, so that the particular software program will only run properly when the authentication key is present. The authentication key may be a device to be connected to a parallel port, or to a serial port, such as a USB (Universal Serial Bus) port, or it may connect wirelessly to a computer or game console.

Such an authentication key, or security tag, may simply comprise a function to check for the authentication key, returning “true” or “false” accordingly, and there by making the protection to a single bit value at one point in the program. A more sophisticated authentication key may comprise built-in encryption features and may use fabrication techniques designed to thwart reverse engineering. Furthermore, authentication keys may also contain non-volatile memory so that key parts of the software actually may be stored within the authentication key.

The particular software program provided with an authentication key may either refuse to run or run in a restricted mode if the key is not present. These hardware keys are provided as a means of digital rights enforcement, e.g. such as copy protection primarily because such hardware elements are much, harder to copy than the software code itself.

In US 2003/0228911, it has furthermore been suggested to provide a console-based gaming system with a dongle so as to enable playback of DVD movies on the gaming system. These gaming systems are dedicated to run video games from a disc, most often loaded from an optical disc drive. A dongle may then store a DVD playback code so that when this code is transferred from the dongle to the gaming system, the gaming system will be able to playback DVD movies.

It is an object of the present invention to provide a software program on two storage media each with a different version of the same program.

According to a first aspect of the invention, the above-mentioned and other objects are fulfilled by means of delivering software comprising at least a first and a second storage medium comprising a first and a second version of a software program, respectively, wherein the first version comprises a full version of the program and the second version comprises a limited version of the program, and wherein the first version of the software program can only be executed in the presence of the second storage medium, or vice versa.

The means of delivering software may comprise a software program package, it may be any computer or game console readable medium, such as CDs, DVDs, BDs, ROM cards, small form factor optical discs, etc., and any combinations of such media.

The first and second storage mediums may be any storage media, and/or any data carriers.

By the term software is in the present context meant any program code or computer program code to be read or interpreted by any processing means, such as by any computer or game console.

According to another aspect of the present invention, a system is provided, wherein the system comprises a data processing unit for executing data stored on a data carrier, and wherein related data are stored on two separate data carriers. At least one of the data carriers comprises identification means (such as a security tag) and wherein the presence of the identification means authorizes the use of one of the data carriers in one of the devices.

The two separate data carriers may be provided for playback in different type of devices.

Preferably, the first storage medium is the primary medium and comprises a full version of the program, so that this full version comprises elements and features, some of which may require relatively rich resources, such as processing power. Examples include advanced full screen graphics, multi-channel sounds, bonus material, etc. The first medium may be any computer readable media, such as a CD-ROM, a DVD, a Blu-ray Disc (BD), etc. The first storage medium is preferably for use with a first device, such a stationary device, such as a stationary computer or a gaming console, such as PlayStation, Xbox, Gamecube, etc.

The second storage medium may then be a secondary medium and comprise a limited version of the program, making limited use of resources such as graphics, sounds, etc., which typically demand both storage capacity and processing power when executing the program. The second storage medium may thus be adapted to be used with a secondary device, such as a portable device, typically having less hardware resources than the stationary devices mentioned above. Preferably, the second storage medium is a removable medium for use with a secondary device, such as a portable or hand held device, such as PSP (PlayStation Portable), GameBoy, mobile phone, etc., and the second storage medium may thus comprise any removable medium, such a CD, a DVD or, preferably, smaller size media, such as memory ICs, ROM cards, small form factor optical discs, flash cards, etc.

In a preferred embodiment, the software program comprises a game program to be played on a gaming console. The full version thus being provided for full experience when playing on a stationary gaming console and the limited edition may then be provided for and adapted to be played on a portable device, such as on a mobile or cellular phone or on a portable game console, such as e.g. GameBoy.

The program version provided on the second storage medium may thus allow for execution of the program, just in a limited version. The second program version may contain all the features of the full program, merely modified to leave out demanding features, such as advanced graphics and/or sounds, and/or the second program version may be able to provide only some features of the full version program.

To avoid use of both programs at the same time or to have an extra protection of the full version, the first version of the program may not be able to run without the presence of the second version of the program. Thus, the second version of the program may also function as a dongle.

A security tag or authentication means may provided with either of the storage mediums, preferably a security tag or identification means are provided with the second storage medium.

The first and second storage media may be associated with each other via identification means, such as for example an RF-ID tag.

Most often, the first device, e.g. the computer or the stationary game console, will check for the presence of the first storage medium and for the presence of the second storage medium, thus both the first and the second storage media need to be accessible from the first device.

In order to identify the second storage medium, the second storage medium may be provided with any identification means readable from the first device. The identification means may be any tag comprising an identification of the second medium, such as a security tag, and the identification means may be any identification number or identification code identifying the specific second storage medium.

Furthermore, the data on the first medium may be encrypted to protect it from misuse. The identification means of the second medium may be included in the key hierarchy that provides the key to decrypt all, or sensitive portions of, the data on the first medium. The identification means may comprise an identification code that may be provided in the form of a disc ID or an RF-ID tag. Alternatively, the tag may be coupled to a disc by individualizing the tag with a disc identifier value, for example by storing a disc identifier value in the tag. The disc identifier value may be unique per title or even per disc. Another possibility for providing a secure link or association between the two storage means, is to use a smart card chip to enable cryptographic operations and secure storage.

Thus, the identification means of the second storage means or the identification means of an RF-ID tag attached to the second storage means may be needed to decrypt (portions of) the data on the first storage means. The identification means of the first storage means may be stored on the second storage means or in a RF-ID tag attached to the second storage means.

The communication between the first and second media may for example be provided by the use of RF (radio frequency) or by NFC (near field communication). The communication may be one directional or bi-directional.

The second storage medium may be provided in the form of a device to be connected to a parallel port of the first device or to a serial port, such as a USB (Universal Serial Bus) port, or to be inserted into a drive, such as a disc drive, of the first device, or it may connect wirelessly to the first device.

The identification means may thus be present on the second storage medium and read by the first device upon insertion of the second storage device into a port or drive of the first device.

In a preferred embodiment, at least the identification means may be wirelessly associated with the first device, so that it may be provided to the first device comprising the first storage medium without occupying a port or drive of the first device. Thus, the first device may access the identification means on the second medium wirelessly so that the identification code may be provided to the first device.

In this way, the identification means may be made accessible to the first device via a wireless connection, such as via optical means, via bluetooth, via electromagnetically means, such as RF, via wireless LAN, etc.

In one embodiment of the invention, the identification means may be made accessible to the first device from a portable device comprising the second storage medium. Thus, a portable device may have a wired or a wireless connection to the first device, such as e.g. a bluetooth or wireless LAN connection allowing the first device access to the identification means.

In a preferred embodiment, the connection is made directly between the first device and the second storage medium, using for example an RF-ID tag, and preferably an RF-ID tag embedded in the second storage medium, which may be interrogated by the first device.

A still further alternative is a cable connection between the first device and the second medium.

The second storage medium may further comprise the digital rights of a user. Thus, a user may have restricted rights, so that access to certain parts of a program are prohibited, these parts being defined by the tag provided on the second storage medium. Thus, a software application program vendor may prefer to provide an application program package to all users, where users then according to a license agreement have access to only parts of the application program package, these parts then being defined on the secondary medium, so that the digital rights defined on the second storage medium in this case limits the use of the first medium.

In a preferred embodiment, the users digital rights are transferred wirelessly to the first device. The digital rights may thus be associated with the identification means, or the identification means may comprise the digital rights.

Furthermore, the digital rights may be updated after the program has been used for a certain amount of time or after the user has reached a certain level of expertise.

The software program may for example be a computer or game console game and the tag may then store parameters, such as game parameters, so that the parameters may be used when e.g. playing on other consoles. Hereby, the same instance of a game may be played alternately on mobile devices and stationary devices. Alternatively or additionally, the tag may comprise a game level meter so that e.g. on-line gaming or network facilities are not available until a certain level has been reached by the user.

The RF-ID tag may thus be used to store progress, e.g. of the game played, to be able to transfer or continue a game played on the mobile platform to/on the stationary platform. The RF-ID tag may also be used as an entrance ticket and identification to the network mode of the game, once you have reached a certain level. Ownership of the RF-tag may also prove later that you are the one who won the game.

Thus, the digital rights may be updated from the first version of the program to the identification means on the second storage medium. The identification means may thus include storage to facilitate the storage of digital rights.

Besides allowing for the play back of the game on two different devices, the RF-ID tag applies the same copy protection and digital rights management, etc. usually provided by dongles. This is achieved because it is much harder to copy the tag than to copy the software it authenticates. Dongles may also be referred to as hardware keys and/or security devices.

Furthermore, a method of providing securely linked media carrying different versions of the same computer code is provided. The method comprising providing a first full version of the software program on a first storage medium, and providing a second limited version of the software program on a second storage medium, wherein the first version of the software program can only be executed in the presence of the second storage medium.

According to a still further aspect of the invention, a system is provided comprising a computer/game console and a driver for reading the means of delivering software as disclosed in claim 1.

FIG. 1 shows a stationary system according to an embodiment of the present invention,

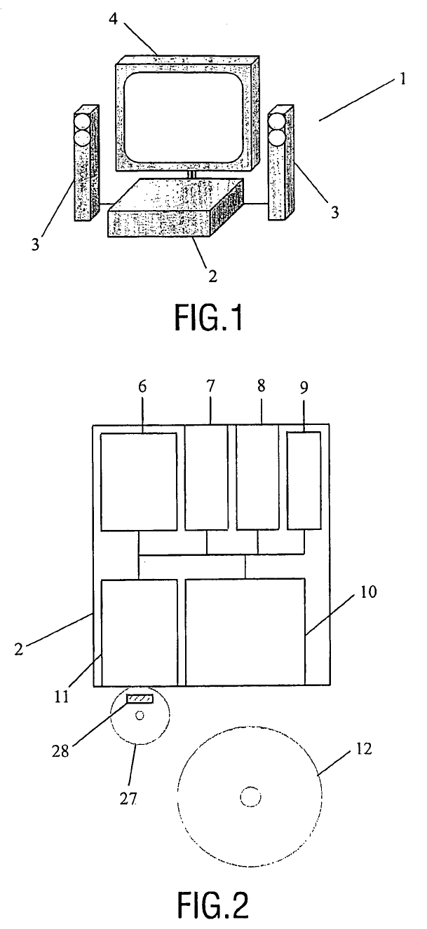

FIG. 2 shows a simplified view of a game console shown in FIG. 1, and

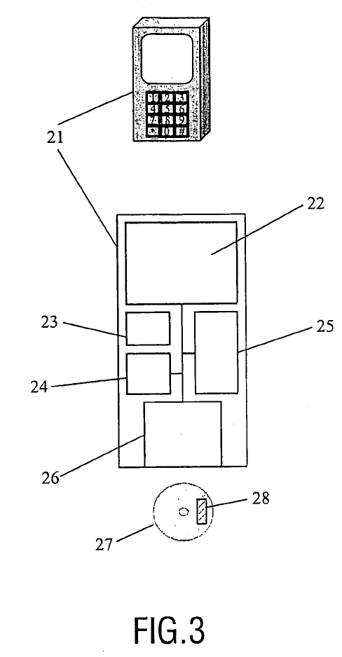

FIG. 3 shows a corresponding mobile device.

A game provider launching a new game may want a user to be able to play the game everywhere. Thus, the provider wants to allow the user to play the game on his game console at home with DVD or Blu-Ray drive, on his portable device or mobile phone with portable blue (PB) drive, and preferably also on the PC of his friend, etc. Furthermore, the game has networking features, but the user is only allowed to use these when he has reached a certain level in the game.

In FIG. 1, a stationary system 1 for playing games, a game console, is shown. In the preferred embodiment, the game console is a Sony PlayStation, Game Cube, X-Box or the like comprising console 2 [this is more then a console, which is just another storage device, in fact it may not include a hard disk. it does include a drive that accepts the first storage means, i.e. a optical disc drive], speakers 3 and a monitor/display 4.

The console [see before] 2 is shown in more detail in FIG. 2. The console comprises a processor or a data processing unit 6, a memory 9, an audio adapter 7 and a display adapter 8. The console further comprises an optical disk drive 10 and an RF-ID reader 11.

The disc drive 10 is adapted to read a disc 12, such as a Blu Ray disc, storing the main or first version of the game.

The RF-ID reader 11 reads a chip 28 on a second storage medium 27. The second storage medium is a small form factor optical disc 27 with an integrated chip 28. The chip comprises an RF-ID tag associated with the game on the disc 12.

Thus, for the stationary system to process the game stored on the disc 12, the game on the disc 12 is read into memory 9, the RF-ID reader 11 reads the RF-ID tag of the second storage medium 27 and the processor 6 compares the ID of the RF-ID tag read with data of the stored game, and only when the processor confirms that the RF-ID tag is associated with the stored game, the user is allowed to play the game on the stationary system. The comparing step may comprise a decryption step, and the key needed to decrypt the data on disc 12 may be a combination of the disc ID of disc 12 and the tag ID of the integrated chip 28, or the key may be stored in encrypted form on disc 12 with the tag ID of the integrated chip 28 being the encryption key.

In order to allow the user to play the game also on mobile devices, the small form factor optical disc 27 comprises a limited version of the game adapted to be played on mobile devices, which typically have less processing power available compared to stationary devices.

In FIG. 3, such a mobile device 21 is shown. The mobile device 21 is a portable gaming facility, e.g. a portable PlayStation (PSP), Game Boy Advance (GBA), or the like. Alternatively, it is a mobile phone with a gaming facility. The PSP comprises a display 22 for displaying information or displaying the game features and speakers 23 to allow the user to hear the audio of the game. Furthermore, an internal memory 24 is provided. Still further a processor 25 and a disc drive 26 are provided. These elements are all interconnected to allow for the playback of a game stored on the disc 27 inserted in the disc drive 26. The disc 27 is the second storage medium and comprises a second version of the game adapted to be played on the portable devices. The disc 26 comprises a chip 28 (a Chip in Disc, CiD). The chip comprises the RF-ID tag.

It is seen that it is now not possible to play the game at two different locations at the same time. The person carrying the RF-ID tag, and the CiD, can play the game on his mobile or at home, but not both places at the same time. The CiD thus acts as a dongle, a security tag or an authentication key for the stationary game and can also be used to store game parameters, such as level information.

As a person skilled in the art will readily appreciate, also other data carriers may be used in other embodiments of the invention. Advantageously, a solid state memory like a ROM, EEPROM or Flash memory may be used to store the limited version of the game.

It will also be apparent from the description that the invention is not solely intended for use with data carriers carrying computer game programmes; also other types of computer programme data may be stored on the data carriers.

1. Means of delivering software, the means comprising at least a first (12) and a second (27) storage medium comprising a first and a second version of a software program, respectively, wherein the first version comprises a full version of the software program and the second version comprises a limited version of the software program, and wherein the first version of the software program can only be executed in the presence of the second storage medium (27).

2. Means of delivering software according to claim 1, wherein the second storage medium (27) is a removable medium.

3. Means of delivering software according to claim 2, wherein the removable medium comprises ROM cards and/or small form factor optical discs.

4. Means of delivering software according to claim 1, wherein the full version requires rich resources.

5. Means of delivering software according to claim 1, wherein the first and second storage media are associated via identification means (28).

6. Means of delivering software according to claim 5, wherein the identification means (28) comprises an RF-ID tag.

7. Means of delivering software according to claim 6, wherein the RF-ID tag is provided on the second storage medium.

8. Means of delivering software according to claim 1, wherein the software program comprises a game program.

9. Means of delivering software according to claim 1, wherein the second storage medium further comprises digital rights of a user.

10. Means of delivering software according to claim 9, wherein the digital rights may be updated from the first version of the program.

11. Means of delivering software according to claim 10, wherein the digital rights comprises a level of a user.

12. A method of providing securely linked media carrying different versions of a software program, the method comprising
providing a first full version of the software program on a first storage medium (12), and
providing a second limited version of the software program on a second storage medium (27),
wherein the first version of the software program can only be executed in the presence of the second storage medium.

13. A software program provided on means of delivering software according to claim 1, wherein the software program comprises a console game program.

14. A system comprising a computer and/or a game console (1), and a driver (10, 11) for reading means of delivering software as disclosed in claim 1.

15. A system comprising a data processing unit for executing data stored on a data carrier, wherein related data are stored on two separate data carriers, at least one of the data carriers comprising identification means and wherein the presence of the identification means authorizes use of one of the data carriers.

16. A system according to claim 15, wherein the two separate data carriers are for playback in different type of devices.
